(19) United States
(12) Patent Application Publication
(10) Pub. No.: US 2017/0034530 A1
(43) Pub. Date: Feb. 2, 2017

(54) REDUCED SIZE INVERSE TRANSFORM FOR DECODING AND ENCODING

(71) Applicant: Microsoft Technology Licensing, LLC, Redmond, WA (US)

(72) Inventors: Victor Cherepanov, Redmond, WA (US); Yongjun Wu, Bellevue, WA (US); Srinath Reddy, Redmond, WA (US); Yuechuan Li, Issaquah, WA (US); Shyam Sadhwani, Bellevue, WA (US); Chihlung Lin, Redmond, WA (US); Binlong Li, Redmond, WA (US)

(73) Assignee: MICROSOFT TECHNOLOGY LICENSING, LLC, Redmond, WA (US)

(21) Appl. No.: 14/811,721

(22) Filed: Jul. 28, 2015

(51) Int. Cl. H04N 19/61; H04N 19/593; H04N 19/139; H04N 19/124; H04N 19/107; H04N 19/18; H04N 19/122; H04N 19/176; H04N 19/119; H04N 19/52; H04N 19/91; H04N 19/70; H04N 19/44

(52) U.S. Cl. CPC H04N 19/61; H04N 19/70; H04N 19/593; H04N 19/139; H04N 19/124; H04N 19/107; H04N 19/44; H04N 19/122; H04N 19/176; H04N 19/119; H04N 19/52; H04N 19/91; H04N 19/18

(57) ABSTRACT

Innovations are provided for encoding and/or decoding video and/or image content using reduced size inverse transforms. For example, a reduced size inverse transform can be performed during encoding or decoding of video or image content using a subset of coefficients (e.g., primarily non-zero coefficients) of a given block. For example, a bounding area can be determined for a block that encompasses the non-zero coefficients of the block. Meta-data for the block can then be generated, including a shortcut code that indicates whether a reduced size inverse transform will be performed. The inverse transform can then be performed using a subset of coefficients for the block (e.g., identified by the bounding area) and the meta-data, which results in decreased utilization of computing resources. The subset of coefficients and the meta-data can be transferred to a graphics processing unit (GPU), which also results in savings in terms of data transfer.

### BACKGROUND

Engineers use compression (also called source coding or source encoding) to reduce the bit rate of digital video. Compression decreases the cost of storing and transmitting video information by converting the information into a lower bit rate form. Decompression (also called decoding) reconstructs a version of the original information from the compressed form. A “codec” is an encoder/decoder system.

Over the last two decades, various video codec standards have been adopted, including the ITU-T H.261, H.262 (MPEG-2 or ISO/IEC 13818-2), H.263 and H.264 (MPEG-4 AVC or ISO/IEC 14496-10) standards, the MPEG-1 (ISO/IEC 11172-2) and MPEG-4 Visual (ISO/IEC 14496-2) standards, and the SMPTE 421M standard. More recently, the HEVC standard (ITU-T H.265 or ISO/IEC 23008-2) has been approved. Extensions to the HEVC standard (e.g., for scalable video coding/decoding, for coding/decoding of video with higher fidelity in terms of sample bit depth or chroma sampling rate, or for multi-view coding/decoding) are currently under development. A video codec standard typically defines options for the syntax of an encoded video bitstream, detailing parameters in the bitstream when particular features are used in encoding and decoding. In many cases, a video codec standard also provides details about the decoding operations a decoder should perform to achieve conforming results in decoding. Aside from codec standards, various proprietary codec formats define other options for the syntax of an encoded video bitstream and corresponding decoding operations.

As the resolution of video content has increased (e.g., from standard definition to high definition, and more recently to ultra-high resolution and 4K), computing resource demands for processing such video content have increased. Therefore, high resolution and ultra-high resolution content can present challenges during encoding or decoding.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques are described for performing reduced size inverse transforms. For example, a reduced size inverse transform can be performed during encoding or decoding of video or image content using a subset of coefficients (e.g., primarily non-zero coefficients) of a given block. For example, a bounding area can be determined for a block that encompasses the non-zero coefficients of the block (e.g., that only contains non-zero coefficients or that also contains some zero-value coefficients). Meta-data for the block can then be generated, including a shortcut code that indicates whether a reduced size inverse transform can be performed and/or a size for the reduced size inverse transform. The inverse transform can then be performed using a subset of coefficients for the block (e.g., identified by the bounding area) and the meta-data.

In some implementations, performing a reduced size inverse transform involves transferring a subset of coefficients for a block, and associated meta-data, to a graphics processing unit (GPU), which increases the efficiency of data transfer to the GPU (e.g., from the central processing unit (CPU) to the GPU). The GPU then performs the reduced size inverse transform using the subset of coefficients according to the information in the meta-data, resulting in reduced computing resource utilization by the GPU.

The foregoing and other objects, features, and advantages of the invention will become more apparent from the following detailed description, which proceeds with reference to the accompanying figures.

### BRIEF DESCRIPTION OF THE DRAWINGS

FIGS. 1a and 1b are diagrams illustrating an example video encoder in conjunction with which some described embodiments can be implemented.

FIG. 2 is a diagram illustrating an example video decoder in conjunction with which some described embodiments can be implemented.

FIG. 3 is a diagram illustrating example operations performed by a computing device implementing a reduced size inverse transform.

FIG. 4 is a diagram illustrating example blocks of coefficients and corresponding meta-data associated with performing a reduced size inverse transform.

FIGS. 5 and 6 are flowcharts of example methods for performing reduced size inverse transforms.

FIG. 7 is a flowchart of an example method for determining whether to apply a reduced size inverse transform to a block based on a bounding area for the block.

FIG. 8 is a diagram of an example computing system in which some described embodiments can be implemented.

### DETAILED DESCRIPTION

The detailed description presents various innovations in performing reduced size inverse transforms. For example, a reduced size inverse transform can be performed during encoding or decoding of video content using a subset of coefficients (e.g., primarily the non-zero coefficients) of a given block. For example, a bounding area can be determined for a block that encompasses the non-zero coefficients of the block (e.g., that only contains non-zero coefficients or that also contains some zero-value coefficients). Meta-data for the block can then be generated, including a shortcut code that indicates whether a reduced size inverse transform can be performed. The inverse transform can then be performed using a subset of coefficients of the block (e.g., identified by the bounding area) and the meta-data. By performing a reduced size inverse transform, computing resource utilization can be reduced. For example, the number of operations that would have been performed for an inverse transform using the full set of coefficients can be significantly reduced.

In some implementations, the subset of coefficients for the block and the meta-data are transferred to a graphics processing unit (GPU). The GPU receives the subset of coefficients and the meta-data, and performs the inverse transform. With a GPU implementation of a reduced size inverse transform, computing resource utilization can be reduced. Specifically, computing resource reduction in terms of data transfer and processing operations can be realized. For example, with an original size inverse transform, all coefficients of a block are transferred to the GPU. However, with a reduced size inverse transform, just the subset of the coefficients of the block are transferred to the GPU (e.g., for a 32×32 original size block where a 4×4 reduced size inverse transform is being performed, only the 4×4 coefficients are transferred to the GPU). In addition, the GPU only has to perform calculations for the subset of coefficients for the reduced size inverse transform (e.g., additional calculations that would otherwise be performed for zero-value coefficients are not performed).

In some implementations, the meta-data comprises a shortcut code that indicates whether a reduced size inverse transform can be performed. For example, the shortcut code can be set to one of a plurality of values. In some implementations, two values are available, one indicating that a reduced size inverse transform will be performed for a block and the other indicating that an original size inverse transform will be performed for the block. In other implementations, more than two values are available (e.g., for indicating multiple sizes for the reduced size inverse transform as well as an original size inverse transform). In some implementations, the presence of the shortcut code indicates that a reduced size inverse transform will be performed (e.g., the absence of the shortcut code can indicate that an original size inverse transform will be performed).

In some implementations, the meta-data also comprises an x-y location (or coordinates) of the block within the picture and/or an original size for the inverse transform. For example, the original size of for the inverse transform can be a value N that specifies an original N by N inverse transform (e.g., for HEVC, the value of N can be between 4 and 32). In some implementations, the meta-data also comprises the location of the coefficient data (e.g., an offset of the block's coefficient data in the picture). The additional meta-data information can be coded separately from the shortcut code, or jointly.

The technologies described herein can be used to perform inverse transforms on blocks of coefficients (e.g., transform coefficients or quantized transform coefficients) for a picture (e.g., a frame or field) of video content (or for a sequence of pictures) or for image content. For example, the blocks of a given picture can be evaluated (e.g., on a block-by-block basis) to determine whether a reduced size inverse transform should be applied for a given block. When a reduced size inverse transform is applied, the reduced size inverse transform can be performed using a subset of the coefficients for the block. When a reduced size inverse transform is not applied, the inverse transform can be performed using the full set of coefficients for the block.

Although operations described herein are in places described as being performed by a video encoder or video decoder, in many cases the operations can be performed by another type of media processing tool (e.g., digital image or digital picture encoder, digital image or digital picture decoder).

Some of the innovations described herein are illustrated with reference to the HEVC video coding standard. The innovations described herein can also be implemented for other standards or formats. For example, the technologies described herein for performing a reduced size inverse transform can be applied to any block based transform encoding/decoding standard.

More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Different embodiments use one or more of the described innovations.

I. Example Video Encoders

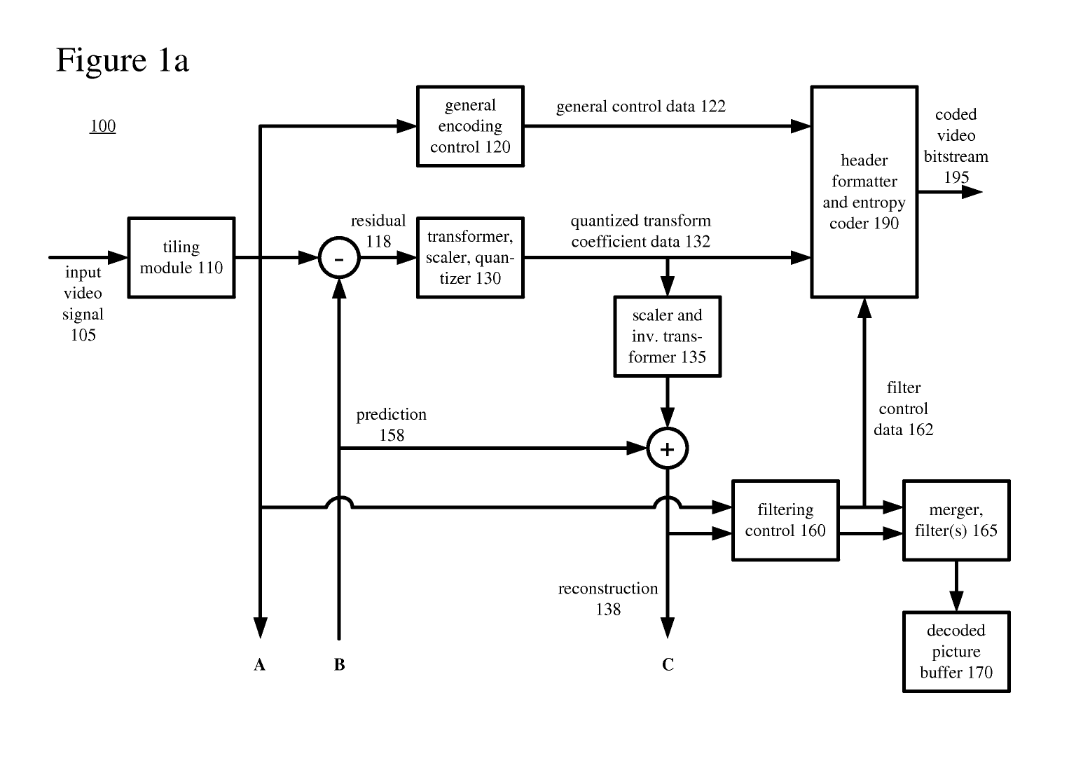

FIGS. 1a and 1b are a block diagram of a generalized video encoder (100) in conjunction with which some described embodiments may be implemented. The encoder (100) receives a sequence of video pictures including a current picture as an input video signal (105) and produces encoded data in a coded video bitstream (195) as output.

The encoder (100) is block-based and uses a block format that depends on implementation. Blocks may be further sub-divided at different stages, e.g., at the prediction, frequency transform and/or entropy encoding stages. For example, a picture can be divided into 64×64 blocks, 32×32 blocks or 16×16 blocks, which can in turn be divided into smaller blocks of sample values for coding and decoding. In implementations of encoding for the HEVC standard, the encoder partitions a picture into CTUs (CTBs), CUs (CBs), PUs (PBs) and TU (TB s).

The encoder (100) compresses pictures using intra-picture coding and/or inter-picture coding. Many of the components of the encoder (100) are used for both intra-picture coding and inter-picture coding. The exact operations performed by those components can vary depending on the type of information being compressed.

A tiling module (110) optionally partitions a picture into multiple tiles of the same size or different sizes. For example, the tiling module (110) splits the picture along tile rows and tile columns that, with picture boundaries, define horizontal and vertical boundaries of tiles within the picture, where each tile is a rectangular region. The tiling module (110) can then group the tiles into one or more tile sets, where a tile set is a group of one or more of the tiles.

The general encoding control (120) receives pictures for the input video signal (105) as well as feedback (not shown) from various modules of the encoder (100). Overall, the general encoding control (120) provides control signals (not shown) to other modules (such as the tiling module (110), transformer/scaler/quantizer (130), scaler/inverse transformer (135), intra-picture estimator (140), motion estimator (150) and intra/inter switch) to set and change coding parameters during encoding. In particular, the general encoding control (120) can decide whether and how to use dictionary modes during encoding. The general encoding control (120) can also evaluate intermediate results during encoding, for example, performing rate-distortion analysis. The general encoding control (120) produces general control data (122) that indicates decisions made during encoding, so that a corresponding decoder can make consistent decisions. The general control data (122) is provided to the header formatter/entropy coder (190).

If the current picture is predicted using inter-picture prediction, a motion estimator (150) estimates motion of blocks of sample values of the current picture of the input video signal (105) with respect to one or more reference pictures. The decoded picture buffer (170) buffers one or more reconstructed previously coded pictures for use as reference pictures. When multiple reference pictures are used, the multiple reference pictures can be from different temporal directions or the same temporal direction. The motion estimator (150) produces as side information motion data (152) such as motion vector data and reference picture selection data. The motion data (152) is provided to the header formatter/entropy coder (190) as well as the motion compensator (155).

The motion compensator (155) applies motion vectors to the reconstructed reference picture(s) from the decoded picture buffer (170). The motion compensator (155) produces motion-compensated predictions for the current picture.

In a separate path within the encoder (100), an intra-picture estimator (140) determines how to perform intra-picture prediction for blocks of sample values of a current picture of the input video signal (105). The current picture can be entirely or partially coded using intra-picture coding. Using values of a reconstruction (138) of the current picture, for intra spatial prediction, the intra-picture estimator (140) determines how to spatially predict sample values of a current block of the current picture from neighboring, previously reconstructed sample values of the current picture.

For the reduced size inverse transform techniques described herein, the encoder (100) can perform the reduced size inverse transform techniques within the scaler/inverse transformer (135). For example, the encoder (100) can obtain the quantized transform coefficient data 132 and apply the reduced size inverse transform techniques using the scaler/inverse transformer (135) in order to generate decoded data values.

The intra-prediction estimator (140) produces as side information intra prediction data (142), such as information indicating whether intra prediction uses spatial prediction or one of the various dictionary modes (e.g., a flag value per intra block or per intra block of certain prediction mode directions), prediction mode direction (for intra spatial prediction). The intra prediction data (142) is provided to the header formatter/entropy coder (190) as well as the intra-picture predictor (145). According to the intra prediction data (142), the intra-picture predictor (145) spatially predicts sample values of a current block of the current picture from neighboring, previously reconstructed sample values of the current picture.

The intra/inter switch selects values of a motion-compensated prediction or intra-picture prediction for use as the prediction (158) for a given block. In non-dictionary modes, the difference (if any) between a block of the prediction (158) and corresponding part of the original current picture of the input video signal (105) provides values of the residual (118). During reconstruction of the current picture, reconstructed residual values are combined with the prediction (158) to produce a reconstruction (138) of the original content from the video signal (105). In lossy compression, however, some information is still lost from the video signal (105).

In the transformer/scaler/quantizer (130), for non-dictionary modes, a frequency transformer converts spatial domain video information into frequency domain (i.e., spectral, transform) data. For block-based video coding, the frequency transformer applies a discrete cosine transform (“DCT”), an integer approximation thereof, or another type of forward block transform to blocks of prediction residual data (or sample value data if the prediction (158) is null), producing blocks of frequency transform coefficients. The encoder (100) may also be able to indicate that such transform step is skipped. The scaler/quantizer scales and quantizes the transform coefficients. For example, the quantizer applies non-uniform, scalar quantization to the frequency domain data with a step size that varies on a frame-by-frame basis, tile-by-tile basis, slice-by-slice basis, block-by-block basis or other basis. The quantized transform coefficient data (132) is provided to the header formatter/entropy coder (190).

In the scaler/inverse transformer (135) a scaler/inverse quantizer performs inverse scaling and inverse quantization on the quantized transform coefficients. An inverse frequency transformer performs an inverse frequency transform, producing blocks of reconstructed prediction residuals or sample values. The encoder (100) combines reconstructed residuals with values of the prediction (158) (e.g., motion-compensated prediction values, intra-picture prediction values) to form the reconstruction (138).

In some implementations, the scaler/inverse transformer (135) performs one or more of the reduced size inverse transform techniques described herein. For example, the scaler/inverse transformer (135) can be implemented by a GPU that receives a subset of the quantized transform coefficient data (132) along with meta-data (not depicted) for a given block and performs a reduced size inverse transform using the subset of the quantized transform coefficient data to produce decoded data values (e.g., blocks of reconstructed prediction residuals or sample values).

For intra-picture prediction, the values of the reconstruction (138) can be fed back to the intra-picture estimator (140) and intra-picture predictor (145). Also, the values of the reconstruction (138) can be used for motion-compensated prediction of subsequent pictures. The values of the reconstruction (138) can be further filtered. A filtering control (160) determines how to perform deblock filtering and sample adaptive offset (“SAO”) filtering on values of the reconstruction (138), for a given picture of the video signal (105). The filtering control (160) produces filter control data (162), which is provided to the header formatter/entropy coder (190) and merger/filter(s) (165).

In the merger/filter(s) (165), the encoder (100) merges content from different tiles into a reconstructed version of the picture. The encoder (100) selectively performs deblock filtering and SAO filtering according to the filter control data (162), so as to adaptively smooth discontinuities across boundaries in the frames. Tile boundaries can be selectively filtered or not filtered at all, depending on settings of the encoder (100), and the encoder (100) may provide syntax within the coded bitstream to indicate whether or not such filtering was applied. The decoded picture buffer (170) buffers the reconstructed current picture for use in subsequent motion-compensated prediction.

The header formatter/entropy coder (190) formats and/or entropy codes the general control data (122), quantized transform coefficient data (132), intra prediction data (142) and packed index values, motion data (152) and filter control data (162). For example, the header formatter/entropy coder (190) uses context-adaptive binary arithmetic coding (“CABAC”) for entropy coding of various syntax elements of a coefficient coding syntax structure.

The header formatter/entropy coder (190) provides the encoded data in the coded video bitstream (195). The format of the coded video bitstream (195) can be a variation or extension of HEVC format, Windows Media Video format, VC-1 format, MPEG-x format (e.g., MPEG-1, MPEG-2, or MPEG-4), H.26x format (e.g., H.261, H.262, H.263, H.264), or another format.

Depending on implementation and the type of compression desired, modules of the encoder can be added, omitted, split into multiple modules, combined with other modules, and/or replaced with like modules. In alternative embodiments, encoders with different modules and/or other configurations of modules perform one or more of the described techniques. Specific embodiments of encoders typically use a variation or supplemented version of the encoder (100). The relationships shown between modules within the encoder (100) indicate general flows of information in the encoder; other relationships are not shown for the sake of simplicity.

II. Example Video Decoders

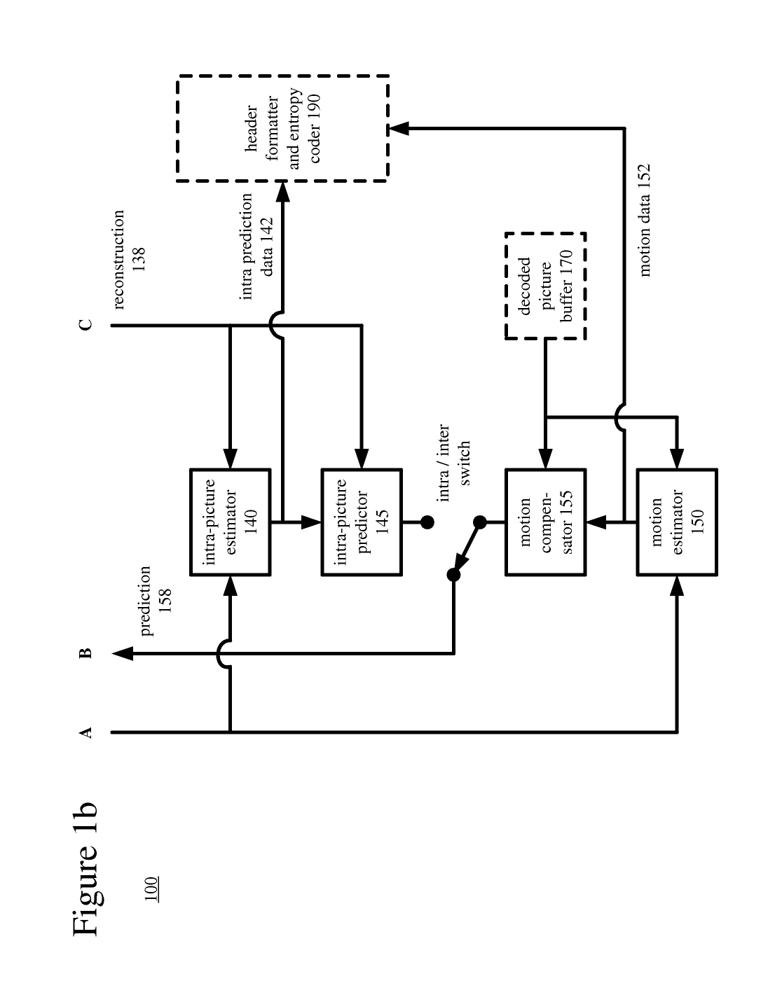

FIG. 2 is a block diagram of a generalized decoder (200) in conjunction with which several described embodiments may be implemented. The decoder (200) receives encoded data in a coded video bitstream (205) and produces output including pictures for reconstructed video (295). The format of the coded video bitstream (205) can be a variation or extension of HEVC format, Windows Media Video format, VC-1 format, MPEG-x format (e.g., MPEG-1, MPEG-2, or MPEG-4), H.26x format (e.g., H.261, H.262, H.263, H.264), or another format.

The decoder (200) is block-based and uses a block format that depends on the implementation and the video codec standard being used. Blocks may be further sub-divided at different stages. For example, a picture can be divided into 64×64 blocks, 32×32 blocks or 16×16 blocks, which can in turn be divided into smaller blocks of sample values. In implementations of decoding for the HEVC standard, a picture is partitioned into CTUs (CTBs), CUs (CBs), PUs (PBs) and TU (TBs).

The decoder (200) decompresses pictures using intra-picture decoding and/or inter-picture decoding. Many of the components of the decoder (200) are used for both intra-picture decoding and inter-picture decoding. The exact operations performed by those components can vary depending on the type of information being decompressed.

A buffer receives encoded data in the coded video bitstream (205) and makes the received encoded data available to the parser/entropy decoder (210). The parser/entropy decoder (210) entropy decodes entropy-coded data, typically applying the inverse of entropy coding performed in the encoder (100) (e.g., context-adaptive binary arithmetic decoding). For example, the parser/entropy decoder (210) uses context-adaptive binary arithmetic decoding for entropy decoding of various syntax elements of a coefficient coding syntax structure. As a result of parsing and entropy decoding, the parser/entropy decoder (210) produces general control data (222), quantized transform coefficient data (232), intra prediction data (242) and packed index values, motion data (252) and filter control data (262).

The general decoding control (220) receives the general control data (222) and provides control signals (not shown) to other modules (such as the scaler/inverse transformer (235), intra-picture predictor (245), motion compensator (255) and intra/inter switch) to set and change decoding parameters during decoding.

If the current picture is predicted using inter-picture prediction, a motion compensator (255) receives the motion data (252), such as motion vector data and reference picture selection data. The motion compensator (255) applies motion vectors to the reconstructed reference picture(s) from the decoded picture buffer (270). The motion compensator (255) produces motion-compensated predictions for inter-coded blocks of the current picture. The decoded picture buffer (270) stores one or more previously reconstructed pictures for use as reference pictures.

In a separate path within the decoder (200), the intra-prediction predictor (245) receives the intra prediction data (242), such as information indicating whether intra prediction uses spatial prediction or one of the dictionary modes (e.g., a flag value per intra block or per intra block of certain prediction mode directions), prediction mode direction (for intra spatial prediction). For intra spatial prediction, using values of a reconstruction (238) of the current picture, according to prediction mode data, the intra-picture predictor (245) spatially predicts sample values of a current block of the current picture from neighboring, previously reconstructed sample values of the current picture.

For the reduced size inverse transform techniques described herein, the decoder (200) can perform the reduced size inverse transform techniques within the scaler/inverse transformer (235). For example, the decoder (200) can obtain the quantized transform coefficient data 232 and apply the reduced size inverse transform techniques using the scaler/inverse transformer (235) in order to generate decoded data values.

The intra/inter switch selects values of a motion-compensated prediction or intra-picture prediction for use as the prediction (258) for a given block. For example, when HEVC syntax is followed, the intra/inter switch can be controlled based on a syntax element encoded for a CU of a picture that can contain intra-predicted CUs and inter-predicted CUs. The decoder (200) combines the prediction (258) with reconstructed residual values to produce the reconstruction (238) of the content from the video signal.

To reconstruct the residual the scaler/inverse transformer (235) receives and processes the quantized transform coefficient data (232). In the scaler/inverse transformer (235), a scaler/inverse quantizer performs inverse scaling and inverse quantization on the quantized transform coefficients. An inverse frequency transformer performs an inverse frequency transform, producing blocks of reconstructed prediction residuals or sample values. For example, the inverse frequency transformer applies an inverse block transform to frequency transform coefficients, producing sample value data or prediction residual data. The inverse frequency transform can be an inverse DCT, an integer approximation thereof, or another type of inverse frequency transform.

In some implementations, the scaler/inverse transformer (235) performs one or more of the reduced size inverse transform techniques described herein. For example, the scaler/inverse transformer (235) can be implemented by a GPU that receives a subset of the quantized transform coefficient data (232) along with meta-data (not depicted) for a given block and performs a reduced size inverse transform using the subset of the quantized transform coefficient data to produce decoded data values (e.g., sample value data or prediction residual data).

For intra-picture prediction, the values of the reconstruction (238) can be fed back to the intra-picture predictor (245). For inter-picture prediction, the values of the reconstruction (238) can be further filtered. In the merger/filter(s) (265), the decoder (200) merges content from different tiles into a reconstructed version of the picture. The decoder (200) selectively performs deblock filtering and SAO filtering according to the filter control data (262) and rules for filter adaptation, so as to adaptively smooth discontinuities across boundaries in the frames. Tile boundaries can be selectively filtered or not filtered at all, depending on settings of the decoder (200) or a syntax indication within the encoded bitstream data. The decoded picture buffer (270) buffers the reconstructed current picture for use in subsequent motion-compensated prediction.

The decoder (200) can also include a post-processing deblock filter. The post-processing deblock filter optionally smoothes discontinuities in reconstructed pictures. Other filtering (such as de-ring filtering) can also be applied as part of the post-processing filtering.

Depending on implementation and the type of decompression desired, modules of the decoder can be added, omitted, split into multiple modules, combined with other modules, and/or replaced with like modules. In alternative embodiments, decoders with different modules and/or other configurations of modules perform one or more of the described techniques. Specific embodiments of decoders typically use a variation or supplemented version of the decoder (200). The relationships shown between modules within the decoder (200) indicate general flows of information in the decoder; other relationships are not shown for the sake of simplicity.

III. Reduced Size Inverse Transforms

This section presents various innovations for performing reduced inverse transforms. For example, a reduced size inverse transform can be performed using a subset of coefficients of a block and based on meta-data indicating parameters (e.g., a shortcut code, a location of the block within a picture, an original transform size, and/or the location of coefficient data) for the reduced size inverse transform.

When a picture of image or video content is encoded, the picture is typically divided into blocks (e.g., 8×8 blocks, 16×16 blocks, or 32×32 blocks). An encoder applies a frequency transform to values for a given one of the blocks to produce transform coefficients for the block. A full inverse frequency transform for a block can be computationally intensive, especially if the implementation of the transform uses floating point multiplications.

Consider, for example, an 8×8 block of sample values or prediction residual values. With a typical block-based transform, the values of the block are converted to 64 transform coefficients, which are organized in a logical two-dimensional (2D) arrangement. Conventionally, horizontal frequency increase from left to right of the logical 2D arrangement, and vertical frequency increases from top to bottom of the logical 2D arrangement. The coefficient with the lowest horizontal frequency and lowest vertical frequency (labeled the DC coefficient) is assigned to the top left corner of the logical 2D arrangement. The other coefficients are labeled AC coefficients. The AC coefficient with the highest horizontal frequency but lowest vertical frequency is assigned to the top right corner of the logical 2D arrangement, the AC coefficient with the highest vertical frequency but lowest horizontal frequency is assigned to the bottom left corner of the logical 2D arrangement, and the AC coefficient with the highest horizontal frequency and highest vertical frequency is assigned to the bottom right corner of the logical 2D arrangement. During decoding, AC coefficients are entropy decoded and assigned to positions in the logical 2D arrangement according to a scan pattern, which maps the coefficients from a logical one-dimensional (1D) arrangement (which tends to cluster zero-value coefficients to facilitate run-length or run-level coding) into the logical 2D arrangement. The actual implementation of the logical 2D arrangement can use a 2D array in which indices i, j indicate coefficient positions, a 1D array in which array indices h (where h=8i+j) indicate coefficient positions, or some other data structure.

A frequency transform tends to cause compaction of the energy of the values of the block, such that lower frequency coefficients have higher amplitude values and higher frequency coefficients have lower amplitude values. When the transform coefficients are quantized for the sake of compression, many of the transform coefficients end up with values of zero. Often, only a few transform coefficients (usually lower frequency coefficients) have non-zero values after quantization. For an 8×8 block, for example, in many cases the non-zero coefficients are localized within a 4×4 section of lower frequency coefficients, a 2×2 section of lower frequency coefficients, or even a 1×1 section (DC coefficient). For a 32×32 block, for example, in many cases the non-zero coefficients are localized within an 8×8 section of lower frequency coefficients, a 7×5 section of lower frequency coefficients, a 4×4 section of lower frequency coefficients, a 2×2 section of lower frequency coefficients, or even a 1×1 section (DC coefficient).

An inverse frequency transform can be complex even for a single block, since it typically involves multiple rounds of computations for 16, 64, 256, 1,024, or more values per block. And when performed hundreds of times per picture, inverse frequency transforms have a high overall computational cost. In addition, the computation cost increases with the size of transform (e.g., a 4×4 inverse transform is much easier than an 8×8 inverse transform). In regular encoding or decoding, this may be the case even when many of the transform coefficients have values of zero. To reduce the computational cost of performing inverse frequency transforms, an encoder or decoder can take advantage of the relative small percentage of non-zero coefficients by implementing a reduced size inverse transform in which only a subset of the coefficients are needed (e.g., for transferring to a GPU). Such reduced size inverse transforms have a lower computational cost and utilize fewer computing resources while producing results that match results from an inverse transform performed using all coefficients.

In some implementations, a bounding area for a block of coefficients is determined. The bounding area represents an area of non-zero coefficients for the block. For example, the bounding area can be determined such that it encompasses all of the non-zero coefficients for the block. For example, for a 32×32 block where all the non-zero coefficients are located in the upper-left 4×4 area, the bounding area can be set to the upper left 4×4 coefficients.

In some implementations, the bounding area is a pre-determined area. For example, a specific implementation could define a 4×4 bounding area for 32×32 blocks (e.g., as the only option for a reduced size inverse transform). In some implementations, a number of pre-determined bounding areas are defined. For example, a specific implementation could define 4×4, 8×8, and 4×8 bounding areas for 32×32 blocks (e.g., as options for reduced size inverse transforms). In some implementations, bounding areas are defined dynamically (e.g., based on the location of non-zero coefficients within the block).

A. Systems Implementing Reduced Size Inverse Transforms

The reduced size inverse transform techniques described herein can be implemented in a video encoder or decoder (or an image encoder or decoder) running on a computing device, such as a desktop computer, laptop, tablet, smart phone, media playback device, gaming console, or another type of computing device.

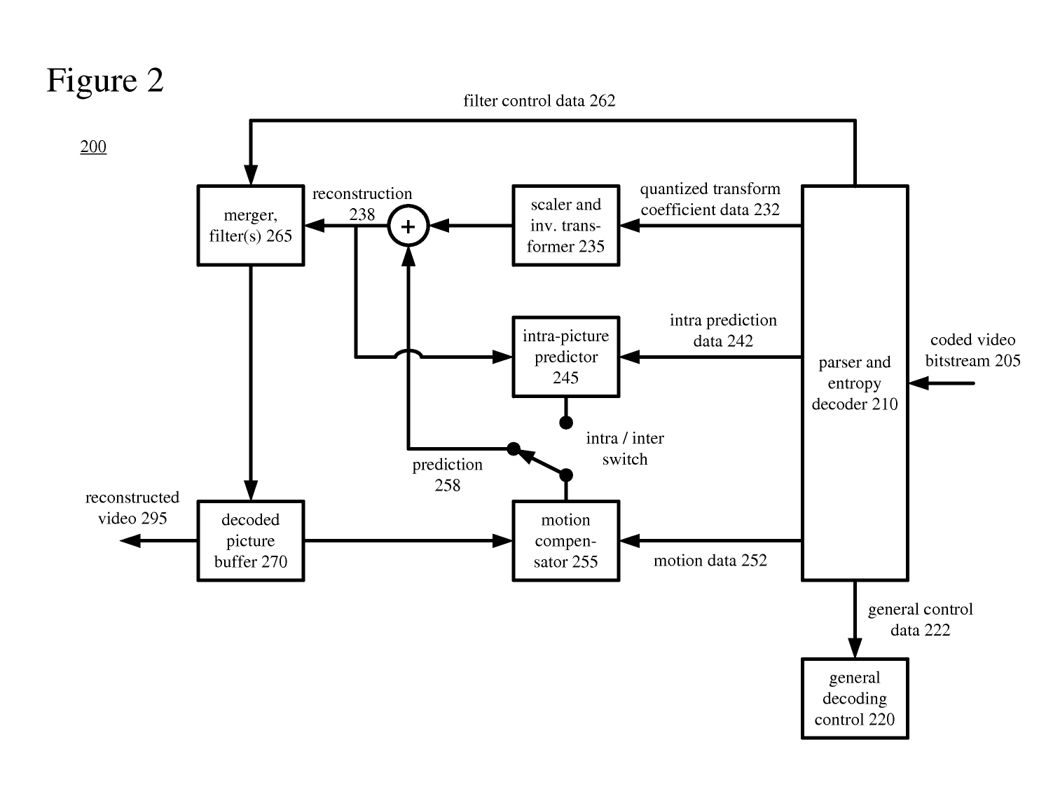

FIG. 3 is a diagram illustrating example operations performed by an example computing device (310) implementing a reduced size inverse transform. As depicted, the computing device (310) performs a number of operations using a CPU (315), and a number of operations using a GPU (340). While only one CPU (315) and one GPU (340) are depicted, the operations can be performed by multiple CPUs (e.g., in a multi-processor and/or multi-core system) and/or multiple GPUs.

The CPU (315) performs a number of operations for a block of coefficients (e.g., quantized transform coefficients). For example, the operations can be performed for each block of a picture. At (320), a bounding area for the block representing an area of non-zero coefficients is determined. For example, the bounding area can be one of a number of pre-determined bounding areas (e.g., a 4×4 bounding area, an 8×8 bounding area, etc.) or a dynamically determined bounding area.

At (322) meta-data for the block is generated. The meta-data comprises a shortcut code indicating a reduced size inverse transform (e.g., the shortcut code can be set to a value indicating that a 4×4 reduced size inverse transform is to be applied instead of a 32×32 original size inverse transform).

At (324) a subset of coefficients of the block (corresponding to the bounding area determined at (320)) and the meta-data are transferred to the GPU (340). For example, the subset of coefficients and the meta-data can be transferred via an internal communication bus of the computing device (310). An example internal communication bus is the PCI Express (Peripheral Component Interconnect Express) bus.

The GPU (340) receives the subset of coefficients and the meta-data from the CPU (315), as depicted at (326). At (350), the GPU (340) performs the reduced size inverse transform for the block using the received subset of coefficients and based on the meta-data. For example, the meta-data could indicate that a 4×4 reduced size inverse transform is to be applied for a 32×32 original size block. The GPU (340) can then perform a 4×4 reduced size inverse transform using a 4×4 subset of coefficients for the block to generate a 32×32 block of data values (e.g. prediction residual data or sample data). The GPU (340) can then perform additional processing (e.g., additional encoding or decoding operations using the prediction residuals or sample data, such as reconstructing the block using prediction data) or send the data values back to the CPU (315) for additional processing.

B. Bounding Areas for Blocks of Coefficients

In the technologies described herein, a bounding area can be determined that represents an area of non-zero coefficients for a block. The bounding area is used to identify the coefficients that will be used for a reduced size inverse transform.

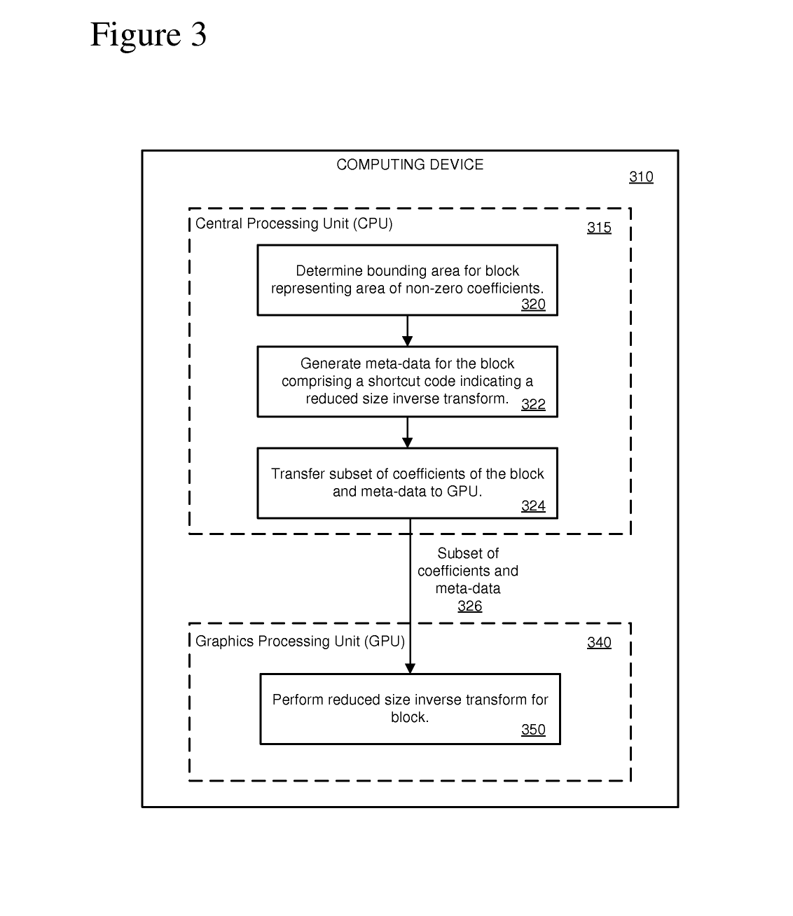

FIG. 4 is a diagram illustrating example blocks of coefficients and corresponding meta-data associated with performing a reduced size inverse transform. In FIG. 4, the example blocks are 8×8 blocks for ease of illustration. However, other block sizes can be used, such as 16×16 blocks, 32×32 blocks, 64×64 blocks, or blocks of other sizes.

At (410), an example 8×8 block of coefficients (e.g., quantized transform coefficients) is depicted. The 8×8 block contains a number of zero-value coefficients (designated by “0”) and a number of non-zero coefficients (designated by “NZ”). As depicted at (410), all of the non-zero coefficients for the 8×8 block are located in the upper left 4×4 area (e.g., as a result of a frequency transform and quantization process during encoding of the block). Therefore, in order to encompass the non-zero coefficients, the bounding area (depicted by the dashed line) encompasses the upper left 4×4 coefficients of the block. As depicted at (410), the bounding area includes all of the non-zero coefficients of the block. However, the bounding area can also include some zero-value coefficients (in this example, there are three zero-value coefficients in the bounding area). Also, as depicted at (410), the bounding area divides the coefficients of the 8×8 block into two groups, a first group of coefficients inside the bounding area (all of the non-zero coefficients of the block and possibly some zero-value coefficients) and a second group of coefficients outside the bounding area (the remaining zero-value coefficients of the 8×8 block).

At (415) example meta-data is depicted which can be used to perform a reduced size inverse transform for the 8×8 block depicted at (410). The example meta-data comprises a shortcut code having a value indicating a 4×4 reduced size inverse transform (corresponding to the 4×4 bounding area). The meta-data also comprises an x-y location. In this example, the x-y location is “0,0” (x and y coordinates from the upper-left of the picture) specifying that this block is located in the upper-left corner of the picture. As another example, an x-y location of “8,0” would specify the block as the second block in the first row of blocks of the picture (in this example, the picture is divided into 8×8 blocks, although a given picture or image may be divided into blocks of other sizes or a mix of different block sizes). The example meta-data also indicates the original transform size for the inverse transform (in this example, the original block size is 8×8).

At (420), a second example 8×8 block of coefficients (e.g., quantized transform coefficients) is depicted. As depicted at (420), all of the non-zero coefficients for the 8×8 block are located in the left 4×8 area (e.g., as a result of a frequency transform and quantization process during encoding of the block). Therefore, the bounding area (depicted by the dashed line) encompasses the left-hand 4×8 coefficients of the block. As depicted at (420), the bounding area includes all of the non-zero coefficients of the block. However, the bounding area can also include some zero-value coefficients (in this example, there are four zero-value coefficients in the bounding area). As illustrated by this example, the bounding area does not have to be square. In some implementations, the bounding area can be rectangular.

At (425) example meta-data is depicted which can be used to perform a reduced size inverse transform for the 8×8 block depicted at (420). The example meta-data comprises a shortcut code having a value indicating a 4×8 reduced size inverse transform (corresponding to the 4×8 bounding area). The meta-data also comprises an x-y location and an original size for the inverse transform.

At (430), a third example 8×8 block of coefficients (e.g., quantized transform coefficients) is depicted. As depicted at (430), all of the non-zero coefficients for the 8×8 block are located in a 7×7 area from the upper-left of the block (e.g., as a result of a frequency transform and quantization process during encoding of the block). However, instead of setting the bounding area to a 7×7 area (which can be done in some implementations), the bounding area in this example is set to the entire 8×8 block. An 8×8 bounding area is selected for the block depicted at (430) because in this example the dimensions of the area of non-zero coefficients is rounded up to the nearest power of two. Therefore, the 7×7 area of non-zero coefficients has been rounded up to an 8×8 area. As another example, a 5×5 or 6×6 area of non-zero coefficients would also be rounded up to an 8×8 area (in an implementation enforcing a power of two constraint on the bounding area dimensions). As yet another example, a 3×3 area of non-zero coefficients would be rounded up to a 4×4 area.

At (435) example meta-data is depicted which can be used to perform an inverse transform for the 8×8 block depicted at (430). Because in this example the bounding area is the entire 8×8 block, the inverse transform is not a reduced inverse transform, but instead is an inverse transform using the full set of coefficients (an original size inverse transform). Therefore, the example meta-data comprises a shortcut code having a value indicating that an original size inverse transform will be applied. The meta-data also comprises an x-y location and an original size for the inverse transform.

In some implementations, the bounding area for a block is determined by examining the coefficients of the block and determining the smallest area (e.g., the smallest x and y dimensions beginning from the upper-left of the block) that encompasses all of the non-zero coefficients of the block. In some implementations, the smallest area is rounded up to the nearest power of two (e.g., in both x and y dimensions together or independently). For example, a 3×3 smallest area can be rounded up to a 4×4 area, or a 3×7 smallest area can be rounded up to a 4×8 area.

In some implementations, the bounding area can be defined by a shape other than square or rectangle. For example, a triangular or circular shape can be used.

In some implementations, the bounding area is determined based decoding or encoding operations. For example, in some coding standards, such as the HEVC coding standard, a last significant coefficient for a block is identified as part of the encoding/decoding process. The last significant coefficient for a given block is the last non-zero coefficient in scan pattern order. When a last significant coefficient is available, determining the bounding area can be simplified. For example, the bounding area can be determined to encompass all of the coefficients up to and including the last significant coefficient taking into account the scan pattern (e.g., a zig-zag scan pattern, a horizontal scan pattern, or another type of scan pattern).

C. Shortcut Code

In the technologies described herein, meta-data for a block can comprise information specifying parameters for performing an inverse transform, including parameters for performing a reduced size inverse transform and/or parameters specifying whether a reduced size inverse transform is to be performed.

In some implementations, the meta-data comprises a shortcut code. The shortcut code can indicate whether a reduced size inverse transform can be applied as well as the size of the reduced size inverse transform. For example, the shortcut code can be set to one of a number of values, including a first value that indicates that a reduced size inverse transform is to be applied to a given block and a second value that indicates that the reduced size inverse transform will not be applied to the given block. For example, a shortcut code could be a single bit set to one of two values as follows:
Value 1—perform reduced size inverse transform (e.g., 4×4 pre-determined reduced size or another pre-determined reduced size)
Value 2—perform original size inverse transform

In some implementations, more than two options are available. For example, the shortcut code can indicate one of a number of sizes for a reduced size inverse transform as well as indicating when an original size inverse transform is to be applied. For example, a shortcut code could bet set to one of four values as follows (e.g., coded using a 2-bit code):
Value 1—4×4 reduced size inverse transform
Value 2—8×8 reduced size inverse transform
Value 3—4×8 reduced size inverse transform
Value 4—original size inverse transform (e.g., as specified by an original size parameter provided within the meta-data)

The shortcut code can be entropy coded or coded using another coding scheme.

In some implementations, the meta-data also comprises an x-y location (or coordinates) of the block within the picture, an original size for the inverse transform, and/or the location of coefficient data (e.g., an offset for the coefficient data within the picture).

D. Methods for Performing Reduced Size Inverse Transforms

This section describes example methods for performing reduced size inverse transforms. The example methods can be applied to encoding and decoding of video data and image data. The example methods can be used when processing the blocks of a video picture or an image (e.g., for each of the blocks of the video picture or image). For example, the methods can be used to determine whether to use a reduced size inverse transform for each of a number of blocks of a picture or image (e.g., decide on a block-by-block basis). The methods can be used to generate meta-data for the blocks based on the decision (e.g., meta-data indicating parameters for a reduced size inverse transform for some blocks and meta-data indicating parameters for an original size inverse transform for other blocks).

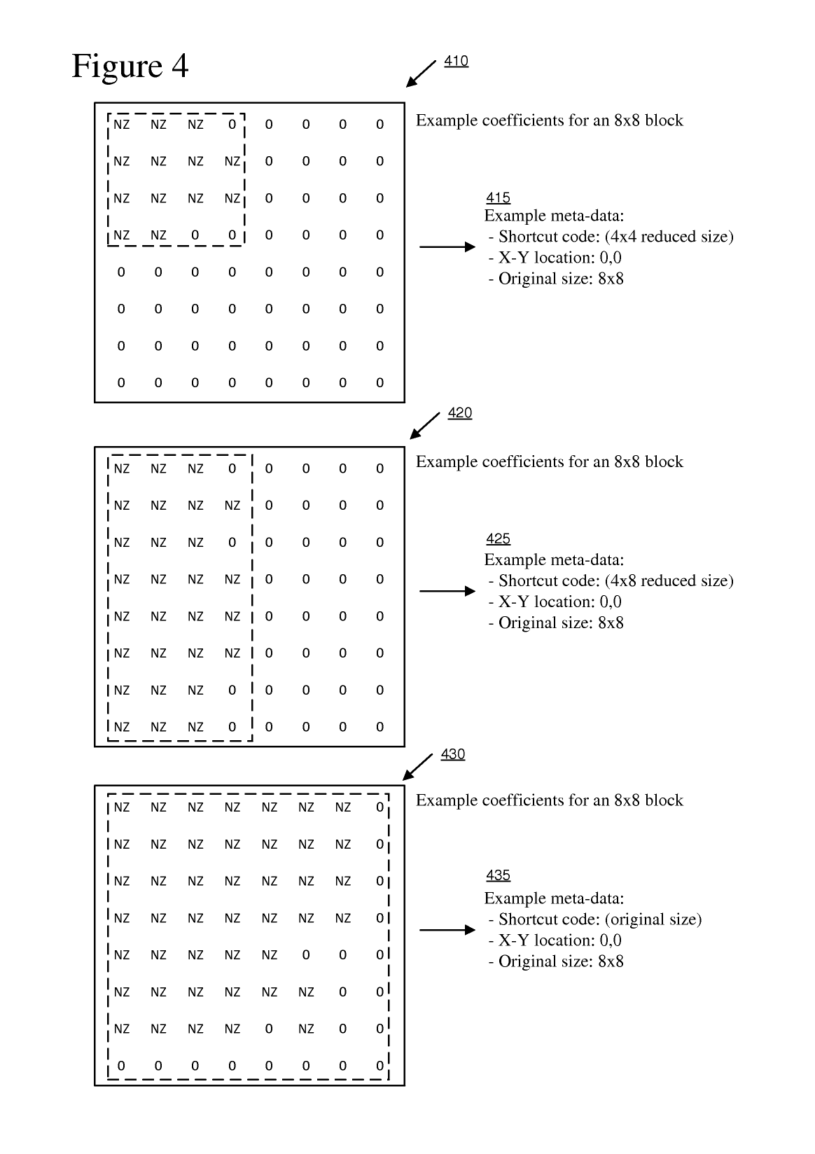

FIG. 5 is an example method (500) for performing a reduced size inverse transform. At (510), a bounding area for a block of coefficients (e.g., quantized transform coefficients) is determined. The bounding area represents an area of non-zero coefficients of the block.

At (520), meta-data for the block is generated. The meta-data comprises a shortcut code indicating a reduced size inverse transform for the block. For example, the shortcut code can indicate a pre-determined size for the reduced size inverse transform (e.g., a 4×4 reduced size inverse transform for a block with an original size of 32×32) or the shortcut code can indicate one of a number of sizes for the reduced size inverse transform (e.g., the shortcut code value can be set to one of a number of values corresponding to one of a number of reduced sizes).

At (530), a subset of coefficients for the block (corresponding to the bounding area for the block determined at (510)) and the meta-data are transferred to a GPU for performing the reduced size inverse transform.

In some implementations, the meta-data comprising the shortcut code indicating a reduced size inverse transform is generated at (520) based upon the bounding area determined at (510). For example, depending on the size of the bounding area, a decision can be made to perform a reduced size inverse transform (which can include deciding which of a number of sizes to use for a reduced size inverse transform) or an original size inverse transform.

In some implementations, the operations depicted at (510) and (520) are performed by a CPU of a computing device, which transfers the meta-data and the subset of coefficients to the GPU, as described at (530).

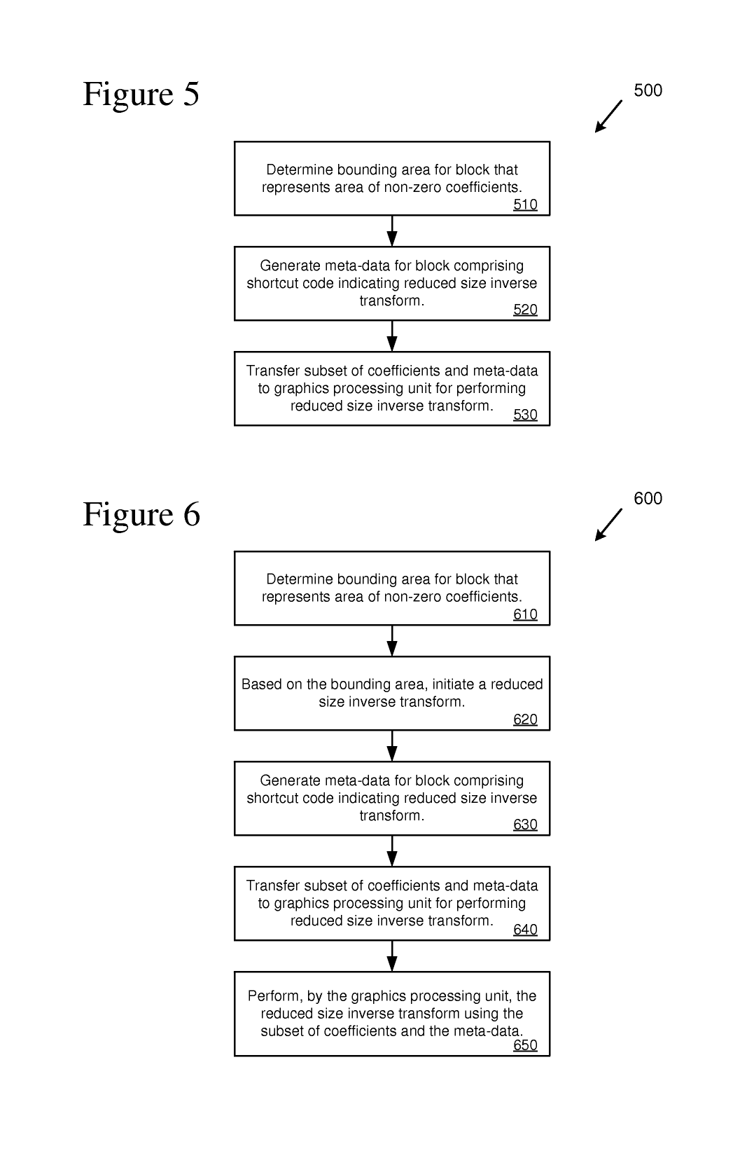

FIG. 6 is an example method (600) for performing a reduced size inverse transform. At (610), a bounding area for a block of coefficients (e.g., quantized transform coefficients) is determined. The bounding area represents an area of non-zero coefficients of the block.

At (620), a reduced size inverse transform is initiated for the block based on the bounding area determined at (620). For example, the reduced size inverse transform can be initiated upon determining that the bounding area is below a cutoff size. For example, if the bounding area is not significantly smaller than the entire block, then performing a reduced size inverse transform may not provide significant savings (e.g., in terms of data transfer and/or computing resources). For example, for a 32×32 original size block, the cutoff size could be 9×9, in which case a bounding area of 8×8 or less would initiate a reduced size inverse transform and a bounding area of greater than 8×8 would initiate an original size inverse transform. Other cutoff sizes could be used depending on implementation details, such as hardware performance or hardware capabilities (e.g., whether hardware acceleration is available).

At (630), meta-data for the block is generated. The meta-data comprises a shortcut code indicating a reduced size inverse transform for the block.

At (640), a subset of coefficients for the block (corresponding to the bounding area for the block determined at (610)) and the meta-data are transferred to a GPU for performing the reduced size inverse transform.

At (650), the GPU performs the reduced size inverse transform using the subset of coefficients and the meta-data. The GPU produced decoded data values for the block (e.g., prediction residuals or sample values).

In some implementations, the operations depicted at (610) through (640) are performed by a CPU of a computing device, which transfers the meta-data and the subset of coefficients to the GPU for performing the reduced size inverse transform, as described at (650).

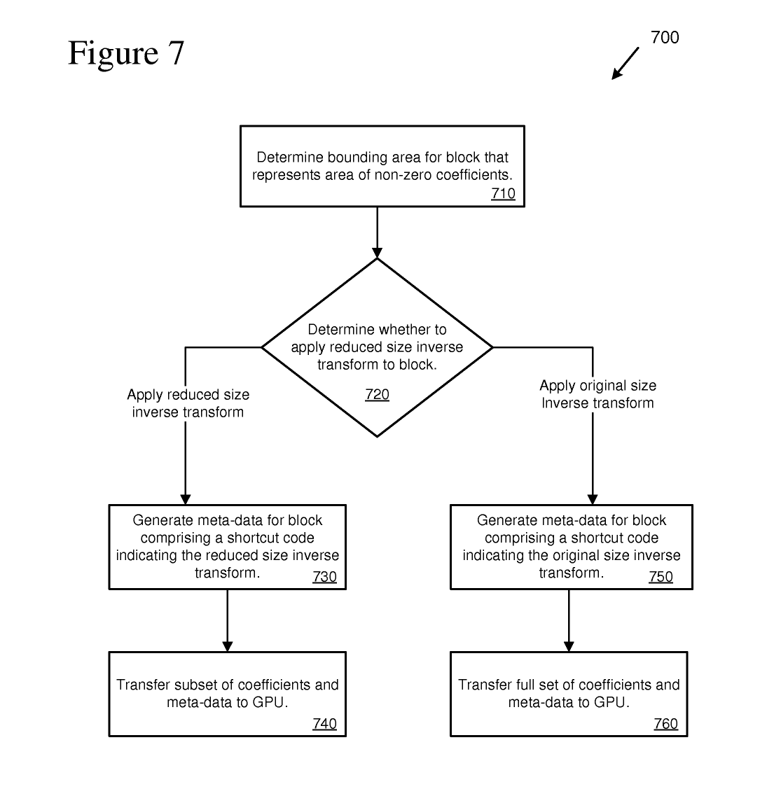

FIG. 7 is an example method (700) for determining whether to apply a reduced size inverse transform to a block based on a bounding area for the block. At (710), a bounding area for a block of coefficients (e.g., quantized transform coefficients) is determined. The bounding area represents an area of non-zero coefficients of the block.

At (720), a determination is made whether to apply a reduced size inverse transform to the block or to apply an original size inverse transform. For example, the determination can be based on the size of the bounding area (e.g., whether the bounding area is below a cutoff size). The cutoff size can be a pre-determined cutoff size associated with the original size of the block (e.g., a 9×9 cutoff size for a 32×32 block, a 5×5 cutoff size for a 16×16 block, etc.). The cutoff size can also be determined based on other criteria, such as the number of coefficients in the bounding area compared to the entire block (e.g., the cutoff can be set to 50% of the coefficients of the block).

If the determination at (720) is to apply a reduced size inverse transform, then the method proceeds to (730) where meta-data for the block is generated. The meta-data comprises a shortcut code indicating a reduced size inverse transform for the block. Then, at (740), a subset of coefficients for the block (corresponding to the bounding area for the block determined at (710)) and the meta-data are transferred to a GPU for performing the reduced size inverse transform.

If the determination at (720) is to apply an original size inverse transform, then the method proceeds to (750) where meta-data for the block is generated. The meta-data comprises a shortcut code indicating an original size inverse transform for the block. Then, at (760), the full set of coefficients for the block and the meta-data are transferred to the GPU for performing the original size inverse transform.

In some implementations, meta-data and coefficient data for each picture (e.g., a video frame or field, or an image) is transmitted to the GPU in two separate data streams. For example, the meta-data stream can include, for each block: a shortcut code, a location of the block within the picture, an original transform size for the block, and the location of coefficient data for the block. The coefficient data stream (e.g., a compacted 16-bit data stream) can be transmitted separately from the meta-data stream. The coefficient data stream contains the coefficients for the blocks of the picture (a subset of coefficients for those blocks having a reduced size inverse transform and a full set of coefficients for those blocks having an original size inverse transform). The location of the coefficient data for a given block can specify an offset of the coefficient data for the given block within the coefficient data stream (e.g., if the first block in the picture has a 4×4 reduced size inverse transform at locations 0-15 of the stream, then the offset for the second block in the picture would be 16). The GPU can then perform the inverse transform according to the meta-data and using the coefficients in the coefficient data stream.

By applying the reduced size inverse transform techniques described herein in an experimental HEVC coding situation, savings of approximately 70% in terms of data transfer from the CPU to the GPU were achieved.

IV. Example Implementation of Reduced Size Inverse Transform

This section presents an example implementation of a reduced size inverse transform when using the HEVC standard. Other implementations can use different calculations for performing a reduced size inverse transform. In addition, the specific calculations performed (e.g., the specific matrix operations) may depend on the coding standard being used.

The N×N inverse transform in the HEVC standard can be described as a multiplication of 3 matrices of size N×N (where N is equal to the transform block size value nTbS). A transposed N×N matrix containing source coefficients A is multiplied with the N×N matrix containing transform coefficients M. It is transposed again and multiplied with the same N×N matrix M.

Formally, the original inverse transform used in HEVC can described according to the following two equations for performing a first multiplication step and a second multiplication step.

$$( Equation 1 \text{-} First multiplication for original inverse transform )$$

$$i [ x , y ] {\sum }_{n = 0}^{nTbS - 1} A [ x , n ] * M [ n , y ] with x = 0 … nTbS - 1 , y = 0 … nTbS - 1$$

$$( Equation 2 \text{-} Second multiplication for original inverse transform )$$

$$d [ x , y ] {\sum }_{n = 0}^{nTbS - 1} i [ n , y ] * M [ n , y ] with x = 0 … nTbS - 1 , y = 0 … nTbS - 1$$

It can be seen from the above equations (Equation 1 and Equation 2) that a 32×32 inverse transform involves 64 k multiplications and 62 k additions in total.

However, statistically only a few coefficients in the source matrix are non-zeros, concentrated towards the lower frequencies (in the top-left corner of the matrix). Therefore, the area of non-zero coefficients can typically be covered by a bounding area of 4×4 or 8×8. Because the rest of the coefficients outside the bonding area are all zero, there is no need to multiply the full N×N matrices. Multiplications involving zero coefficients can be avoided, thus reducing the total number of required multiplications and additions. The solution is a special “significantly reduced” matrix multiplication form that uses only the bounding area containing the non-zero coefficients of the source/intermediate matrix to exactly produce the full intermediate/destination matrix, fully conformant with the HEVC standard.

In this example implementation, the “reduced” matrix multiplication operations for a reduced size inverse transform are described using the following two equations (where all non-zero coefficients are located in the area nX×nY).

$$( Equation 3 \text{-} First multiplication for reduced size inverse transform )$$

$$i [ x , y ] {\sum }_{n = 0}^{nY - 1} A [ x , n ] * M [ n , y ] with x = 0 … n X - 1 , y = 0 … nTbS - 1$$

$$( Equation 4 \text{-} Second multiplication for reduced size inverse transform )$$

$$d [ x , y ] {\sum }_{n = 0}^{n X - 1} i [ n , y ] * M [ n , y ] with x = 0 … nTbS - 1 , y = 0 … nTbS - 1$$

As an example, if all the non-zero coefficients for a 32×32 transform lie within an 8×8 bounding area, the number of computations can be reduced to 10 k multiplications and 9 k additions (as compared to the 64 k multiplications and 62 k additions as mentioned above for the original size inverse transform).

V. Example Computing Systems

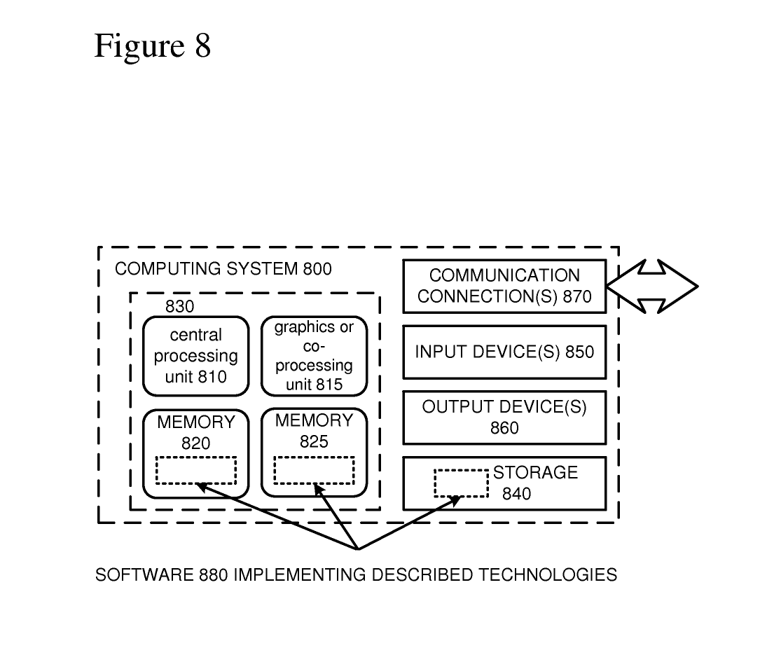

FIG. 8 illustrates a generalized example of a suitable computing system (800) in which several of the described innovations may be implemented. The computing system (800) is not intended to suggest any limitation as to scope of use or functionality, as the innovations may be implemented in diverse general-purpose or special-purpose computing systems.

With reference to FIG. 8, the computing system (800) (also called a computing device) includes one or more processing units (810, 815) and memory (820, 825). The processing units (810, 815) execute computer-executable instructions. A processing unit can be a general-purpose central processing unit (“CPU”), processor in an application-specific integrated circuit (“ASIC”) or any other type of processor. In a multi-processing system, multiple processing units execute computer-executable instructions to increase processing power. For example, FIG. 8 shows a central processing unit (810) as well as a graphics processing unit or co-processing unit (815). The tangible memory (820, 825) may be volatile memory (e.g., registers, cache, RAM), non-volatile memory (e.g., ROM, EEPROM, flash memory, etc.), or some combination of the two, accessible by the processing unit(s). The memory (820, 825) stores software (880) implementing one or more of the innovations described herein, in the form of computer-executable instructions suitable for execution by the processing unit(s).

A computing system may have additional features. For example, the computing system (800) includes storage (840), one or more input devices (850), one or more output devices (860), and one or more communication connections (870). An interconnection mechanism (not shown) such as a bus, controller, or network interconnects the components of the computing system (800). Typically, operating system software (not shown) provides an operating environment for other software executing in the computing system (800), and coordinates activities of the components of the computing system (800).

The tangible storage (840) may be removable or non-removable, and includes magnetic disks, magnetic tapes or cassettes, CD-ROMs, DVDs, or any other medium which can be used to store information and which can be accessed within the computing system (800). The storage (840) stores instructions for the software (880) implementing one or more of the innovations described herein.

The input device(s) (850) may be a touch input device such as a keyboard, mouse, pen, or trackball, a voice input device, a scanning device, or another device that provides input to the computing system (800). For video, the input device(s) (850) may be a camera, video card, TV tuner card, or similar device that accepts video input in analog or digital form, or a CD-ROM or CD-RW that reads video samples into the computing system (800). The output device(s) (860) may be a display, printer, speaker, CD-writer, or another device that provides output from the computing system (800).

The communication connection(s) (870) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Any of the disclosed innovations can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 8, computer-readable storage media include memory (820) and (825), and storage (840). The term computer-readable storage media does not include signals and carrier waves. In addition, the term computer-readable storage media does not include communication connections (e.g., (870)).

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

The disclosed methods can also be implemented using specialized computing hardware configured to perform any of the disclosed methods. For example, the disclosed methods can be implemented by an integrated circuit (e.g., an ASIC (such as an ASIC digital signal process unit (“DSP”), a graphics processing unit (“GPU”), or a programmable logic device (“PLD”), such as a field programmable gate array (“FPGA”)) specially designed or configured to implement any of the disclosed methods.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims.

What is claimed is:

1. A computing device comprising:
a central processing unit; and
a graphics processing unit;
the computing device configured to perform operations during video or image encoding or decoding, the operations comprising, for each block of a plurality of blocks of a picture:
determining a bounding area for the block that represents an area of non-zero coefficients of the block;
generating meta-data for the block, the meta-data comprising a shortcut code indicating a reduced size inverse transform for the block; and
transferring to the graphics processing unit:
a subset of coefficients of the block corresponding to the bounding area for the block; and
the meta-data for the block;
wherein the graphics processing unit performs the reduced size inverse transform for the block using the subset of the coefficients of the block according to the meta-data for the block.

2. The computing device of claim 1 wherein the bounding area is defined by x and y dimensions that divide the coefficients of the block into two groups:
a first group within the x and y dimensions that comprises all non-zero coefficients of the block; and
a second group outside the x and y dimensions that consists of zero-value coefficients of the block.

3. The computing device of claim 2 wherein the x and y dimensions defining the bounding area represents the area of non-zero coefficients of the block rounded up to a nearest power of two.

4. The computing device of claim 1 wherein determining the bounding area for the block comprises:
identifying a last significant coefficient for the block, wherein the last significant coefficient for the block is a last non-zero coefficient of the block according to a scan pattern, wherein the bounding area encompasses the last significant coefficient.

5. The computing device of claim 1 wherein the meta-data further comprises:
an x-y location of the block within the picture; and
an original size for the inverse transform.

6. The computing device of claim 1 wherein the reduced size inverse transform is initiated upon determining that bounding area is below a cutoff size.

7. The computing device of claim 1 wherein the shortcut code is signaled via a single bit with a bit value that identifies pre-determined dimensions for the reduced size inverse transform.

8. The computing device of claim 1 the operations further comprising:
outputting decoded data for the block.

9. The computing device of claim 1 wherein the block contains quantized transform coefficients.

10. In a computing device with a video or image encoder or decoder, a method comprising:
for each block of a plurality of blocks of a picture:
using a central processing unit of the computing device:
determining a bounding area for the block that represents an area of non-zero coefficients of the block;
based on the bounding area, initiating a reduced size inverse transform comprising:
generating meta-data for the block, the meta-data comprising a shortcut code indicating the reduced size inverse transform for the block; and
transferring to a graphics processing unit of the computing device:
a subset of coefficients of the block corresponding to the bounding area for the block; and
the meta-data for the block; and
using the graphics processing unit of the computing device:
performing the reduced size inverse transform for the block using the subset of the coefficients of the block according to the meta-data for the block to produce decoded data values for the block.

11. The method of claim 10 wherein the bounding area is defined by x and y dimensions that divide the coefficients of the block into two groups:
a first group within the x and y dimensions that comprises all non-zero coefficients of the block; and
a second group outside the x and y dimensions that consists of zero-value coefficients of the block.

12. The method of claim 10 wherein determining the bounding area for the block comprises:
identifying a last significant coefficient for the block, wherein the last significant coefficient for the block is a last non-zero coefficient of the block according to a scan pattern, wherein the bounding area encompasses the last significant coefficient.

13. The method of claim 10 wherein the meta-data further comprises:
an x-y location of the block within the picture;
an original size for the inverse transform; and
an offset indicating a location of the subset of coefficients of the block in a coefficient data stream.

14. The method of claim 10 wherein the reduced size inverse transform is initiated upon determining that bounding area is below a cutoff size.

15. The method of claim 10 further comprising:
reconstructing the block using, at least in part, the decoded data values for the block.

16. A computer-readable storage medium storing computer-executable instructions for causing a computing device to perform operations during video or image encoding or decoding, the operations comprising:
for each block of a plurality of blocks of a picture:
determining a bounding area for the block that represents an area of non-zero coefficients of the block;
determining whether to apply a reduced size inverse transform to the block based on the bounding area;
upon determining to apply the reduced size inverse transform to the block:
generating meta-data for the block, the meta-data comprising:
a shortcut code indicating the reduced size inverse transform for the block;
an x-y location of the block within the picture; and
an original size for the inverse transform; and
transferring to a graphics processing unit:
a subset of coefficients of the block corresponding to the bounding area for the block; and
the meta-data for the block;
wherein the graphics processing unit performs the reduced size inverse transform for the block using the subset of the coefficients of the block according to the meta-data for the block to produce decoded data values for the block.

17. The computer-readable storage medium of claim 16 wherein the bounding area is defined by x and y dimensions that divide the coefficients of the block into two groups:
a first group within the x and y dimensions that comprises all non-zero coefficients of the block; and
a second group outside the x and y dimensions that consists of zero-value coefficients of the block.

18. The computer-readable storage medium of claim 16 wherein determining whether to apply a reduced size inverse transform comprises comparing the bounding area to a cutoff size.

19. The computer-readable storage medium of claim 16 wherein the shortcut code indicating the reduced size inverse transform for the block is selected from a plurality of available shortcut codes correspond to a plurality of different sizes for the reduced size inverse transform.

20. The computer-readable storage medium of claim 16 the operations further comprising:
upon determining not to apply the reduced size inverse transform to the block:
generating meta-data for the block, the meta-data comprising:
a shortcut code indicating an original size inverse transform for the block;
the x-y location of the block within the picture; and
the original size for the inverse transform
transferring to the graphics processing unit:
a full set of coefficients of the block; and
the meta-data for the block;
wherein the graphics processing unit performs the original size inverse transform for the block using the full set of the coefficients of the block according to the meta-data for the block to produce decoded data values for the block.
